(19) United States
(12) Patent Application Publication
(10) Pub. No.: US 2010/0257359 A1
(43) Pub. Date: Oct. 7, 2010

(54) METHOD OF AND APPARATUS FOR PROTECTING PRIVATE DATA ENTRY WITHIN SECURE WEB SESSIONS

(76) Inventor: Mark Currie, Durban (ZA)

Correspondence Address: YOUNG & THOMPSON, 209 Madison Street, Suite 500, Alexandria, VA, 22314, US

(21) Appl. No.: 12/742,450

(22) PCT Filed: Nov. 11, 2008
(86) PCT No.: PCT/ZA2008/000104

§ 371 Date: May 12, 2010

(30) Foreign Application Priority Data
Nov. 12, 2007 (ZA) 2007/09797

(51) Int. Cl. H04L 9/32; G06F 21/00

(52) U.S. Cl. 713/168; 713/186

(57) ABSTRACT

A method of providing secure communication over a communication network from a client computer to at least one server computer using a cryptographic security protocol which includes the steps of connecting a secure hardware device to the client computer, and using the device to prevent disclosure on the client computer of login and private information of a user of the client computer.

### BACKGROUND OF THE INVENTION

This invention relates to a method of and apparatus for protecting the entry of data such as PINs, passwords, credit card numbers, ID numbers, beneficiary account numbers, and similar information (hereinafter referred to as “private data”) during secure web sessions such as HTTPS¹.

At least the following threats are posed to a user during a web session:
Fake website: Any website can be faked by copying its web pages and mimicking its actions. A web address can also be faked by hiding the real web address while displaying the original. There is no way to guarantee the legitimacy of a visited website other than by subsequent actions that may or may not take place by which time it may be too late to prevent any undesired consequences. Fraudulent websites can be used to lure people into typing private data onto a fake web page. The private data, once accessed, can be used to commit fraud.
Hacked PC: The integrity of a PC (personal computer) connected to the Internet cannot be trusted. There is no way for a user to guarantee that a PC has not been hacked other than by subsequent actions that may or may not take place by which time it may be too late to prevent any undesired consequences. Furthermore Trojans can easily infect PCs through USB memory sticks or diskettes. Firewalls and anti-virus software do help, but they mainly play a catch-up game. For instance, software designed specifically to exploit Internet banking is unlikely to be detected by anti-virus software as the banking software would not fit the typical profile of a software virus. It is more likely to be highly targeted and not necessarily self-replicating. Only widespread viruses get detected quickly on the Internet and can therefore be analysed and counteracted by anti-virus software vendors.
A hacked PC leaves a user open to attacks such as “keyboard sniffing” whereby information (login passwords etc.) typed in on a PC keyboard is recorded. Even harder to detect is hacking via a modified browser that can manipulate information such as a beneficiary account number by replacing it with a fraudulent account number during an Internet banking session. This technique, which is often referred to as a “man-in-the-browser” attack, can be used to defeat one-time-password systems used by many banks and other web service providers.
Too many passwords: PC users who must remember a number of different login passwords and who may doubt their capability to remember them all, tend to record the passwords in writing. The passwords, if needed regularly, may be written in convenient locations which make the passwords vulnerable to observation by third parties. The prevalence of powerful password cracking software forces users to choose complicated and hard-to-remember passwords, which makes it difficult to commit even one password to memory.
Social engineering: Many people are duped into revealing personal information through email and social websites. Fake emails can appear to originate from legitimate organisations. Appeals for help can appear to be plausible particularly if they are based on current stories in newspapers or on TV. Fraudsters exploit these social vulnerabilities to coerce users to reveal personal details and private data.

It is thus not difficult to obtain unauthorised access to the passwords of an average PC user. Such access does not require the expertise of an experienced engineer since highly effective hacking software can be found on the Internet. The crux of the problem is that the entry of private data is entered in plain text form on a PC. This data can therefore easily be captured by a website through a fake login form, or it can be locally intercepted on the user's PC.

It is an object of the present invention to provide a method of, and apparatus for, protecting the entry of private data, during a web session, at least against the aforementioned threats.

### SUMMARY OF THE INVENTION

The invention provides a method of providing secure communication over a communication network from a client computer to at least one server computer using a cryptographic security protocol which includes the steps of connecting a secure hardware device to the client computer, and using the device to prevent disclosure on the client computer of information of a user of the client computer, wherein the information is selected from login information, and private data, of the user.

The communication network may be the Internet and the cryptographic security protocol may be an Internet browser security protocol such as a secure sockets layer (SSL)² or a transaction security layer (TLS).

The secure hardware device may include a secure memory and the method may include the step of storing information in the memory, with the information being selected from, at least, the network address of the server computer, information which allows the identity of the server computer to be verified by the cryptographic security protocol, the user's server login information and the user's digital certificate (“user” means a user of the client computer).

The method may include the step of displaying the identity of the server computer on the secure hardware device. The identity may for example take the form of the name of the organisation owning (controlling) the server computer, the name of the server, or the server computer's network address.

Information may be stored in a secure memory of the secure hardware device. This information may allow the identity of the server computer to be verified by the cryptographic security protocol. Upon verification the secure hardware device may automatically connect the client computer to the server computer and log in to the server computer on behalf of the user. However, if verification is unsuccessful a warning to the user may be generated.

Automatic login to the server computer may be allowed only if the identity of the user has been verified by the hardware device. This may be done in a plurality of ways and the invention is not limited in this regard. For example a personal identification number which is input by the user to the secure hardware device may be verified. Biometric data of the user, for example fingerprint or iris data, may also be subject to verification. A smart card reader could also be used in place of, or in addition to, the aforegoing to verify the user identity using a smart card. These verification procedures are given by way of non-limiting examples. A PIN, or biometric data, could be encoded on a smart card.

Non-login information may be pre-stored in the hardware security device or the user may be allowed to enter such information into the hardware security device. This information may include personal information of the user such as a credit card number, an identity number, physical address details or the like. The non-login information may be sent from the hardware security device to the server computer without displaying such information in unencrypted form on the client computer.

The server computer may be employed to verify the identity of the user by using the cryptographic security protocol.

The method may include the step of using a keyword in unencrypted data from the server computer or from the client computer as a directive to the hardware security device to achieve one or more functions e.g. to display, insert or substitute information and to perform a digital signature function.

The invention also extends to a secure hardware device for use with a client computer which is connected by a communication network, using a cryptographic security protocol, with at least one server computer, with the device including a data input mechanism, operable by a user of the client computer, at least one user notification display and a communication link to the client computer, and wherein a communication interface to the client computer is provided by a software security program which runs on the client computer.

The display, also referred to as a user notification display, inter alia because it displays information directed to the user, may be of any suitable kind and by way of example only may be selected from a liquid crystal display and a light emitting diode display. The communication link may also be of any suitable kind and in one example is a communication cable.

The security device may implement one or more techniques for verifying the identity of the user. Use may be made of at least one of the following: verification of a personal identification number which is input by a user using the data input mechanism, verification of biometric data. The verification may be done by the device itself or with the aid of a user-inserted smart card which stores the user personal identification number or a template for biometric verification.

The data input mechanism may be of any appropriate kind and may be in the nature of a keyboard. The biometric data verifier may derive its input from a fingerprint reader, an iris scanner or a similar biometrically based device.

### BRIEF DESCRIPTION OF THE DRAWINGS

The invention is further described by way of example with reference to the accompanying drawings in which :

FIG. 1 illustrates hardware components employed in a secure system according to the invention,

FIG. 2 illustrates a secure hardware device according to the invention which is employed in the system of FIG. 1,

FIG. 3 illustrates steps in a local login procedure,

FIG. 4 illustrates steps in an automatic website login procedure,

FIG. 5 illustrates, in block diagram form, a method of automatically logging in to a website,

FIG. 6 is a flow diagram of steps during a manual website login process,

FIG. 7 illustrates in block diagram form a process of keyword substitution during a login procedure,

FIG. 8 illustrates steps during the pre-programming of a login web page address, and

FIG. 9 is a flow chart of steps followed in recording a new website and random (unknown) password.

### DESCRIPTION OF PREFERRED EMBODIMENT

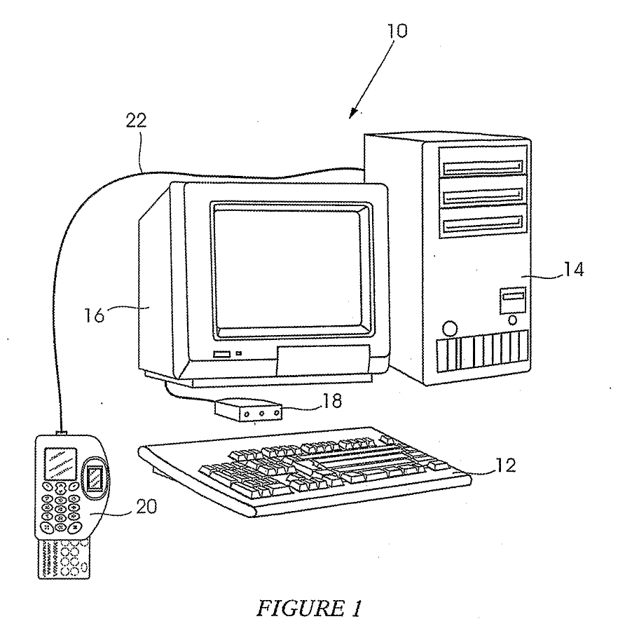

FIG. 1 of the accompanying drawings illustrates a secure login system 10 according to the invention. The system includes a conventional keyboard 12, a case or tower 14 which contains a processor and data input and output devices such as compact discs, a display screen 16 and a data receiving device 18 responsive to a wireless mouse (not shown). The preceding components are conventional and no novelty is claimed in respect thereof. The system includes a small secure hardware device 20 which is connected by a communication link such as a communication cable 22 to a USB port (not shown) of the processor 14, and a software browser interface program referred to herein as a cryptographic service provider (CSP).

In general terms the secure system 10 allows private data (as hereinbefore defined) to be inserted securely into a cryptographic communication stream in such a way that the private data only appears on the processor 14, or on a network to which the processor is connected e.g. the Internet, in encrypted form. The private data can be pre-stored in the device 20 and can be selected with the aid of a menu, as is hereinafter described. The device 20 can also automatically insert pre-stored data into the communication stream based on the detection of keywords in an unencrypted communication stream as is hereinafter described. Alternatively, the private data can be input by a user of the system into the device 20, when required, using a keyboard which is provided on the device.

The device 20 hooks into the browser's SSL/TLS encryption process and therefore does not require any back-end service provider support. The private data is secured between the device 20 and a web server and thereby thwarts hacking techniques such as keyboard sniffing, “phishing” and its variants, spoofing, man-in-the middle and man-in-the-browser attacks.

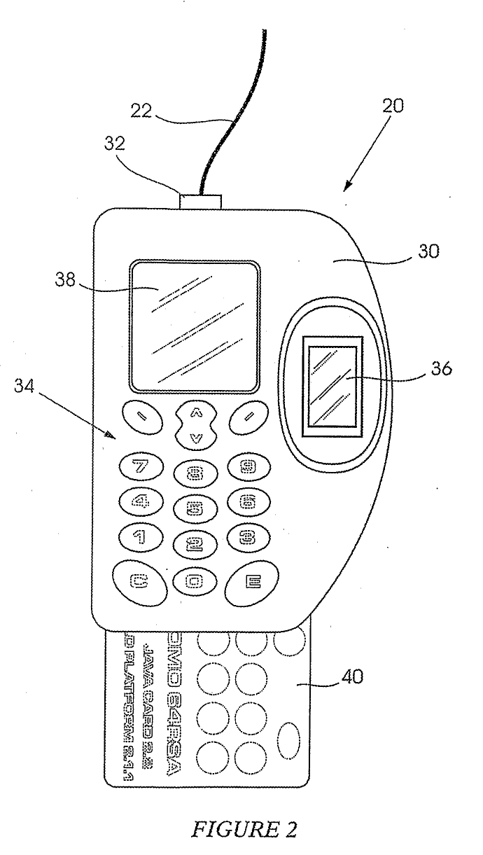

FIG. 2 illustrates the device 20 on a larger scale than that employed in FIG. 1. The device has a housing 30 which contains a processor (not shown). A USB port 32 provides a connection point for the cable 22 which extends to the USB port on the processor 14. A keypad 34 is provided on the front face of the housing. This face also carries a biometric sensor 36 such as a fingerprint or iris sensor.

A display screen 38, in the form of a liquid crystal display or a light emitting diode display, is provided on a front face of the housing. The device 20 has a smart card reader incorporated internally and, as is shown in FIG. 2, a smart card 40 can be inserted into a slot in a side of the housing for interaction with the smart card reader.

The software browser interface program (CSP) is installed as part of the Internet security protocol (SSL/TLS) of the processor 14. The CSP acts as an interface between the browser and the device 20 and allows the device to perform the SSL/TLS security function.

The device 20 appears to the processor 14 as a standard USB HID³ keyboard and therefore requires no device driver installation. The keypad 34 is used for menu navigation and for entering information. The fingerprint sensor 36 and the smart card reader are optional.

The device 20 can also appear as a compound USB device supporting additional USB standards such as a mass storage device and a communication device class (CDC).

With a Windows operating system the CSP, of type RSA SChannel, is set to the default CSP used by the browser for SSL/TLS. On a Linux platform the CSP conforms to the standard PKCS#11 interface used by major browsers on Linux. The CSP could also take the form of an SSL/TLS proxy which supports multiple platforms.

The device requires a user to login before the device can be operated. In an elementary configuration the device login can be done using only a personal identification number (PIN). Additional login options require the presence of the smart card 40 and biometric (e.g. fingerprint) authentication.

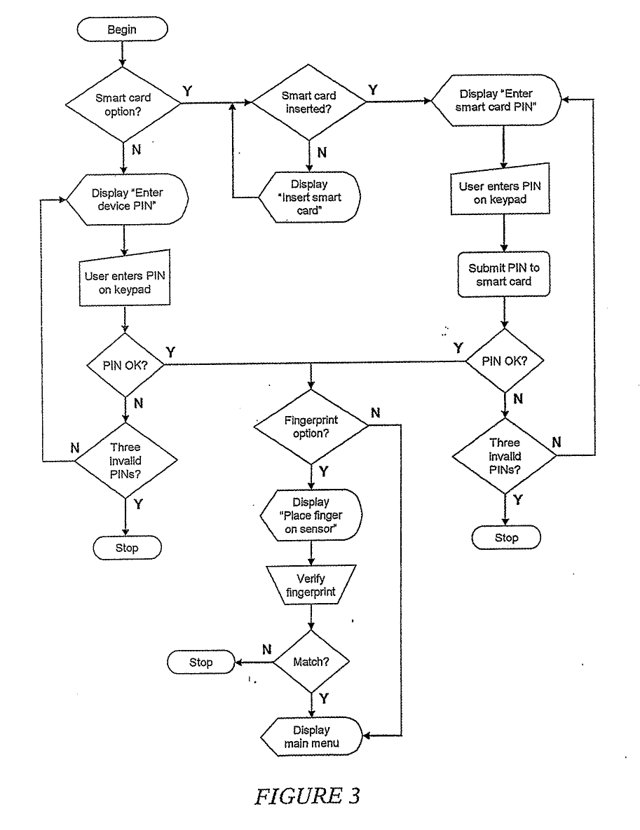

FIG. 3 is a flow diagram of a local login procedure and covers the possibility of the user entering a PIN via the keypad 34, the possible use of a smart card and the possible use of a fingerprint sensor. The flowchart is readily followed and subject to authentication requirements being met the user is, ultimately, presented with a main menu which is displayed on the display screen 38 (block 44 in FIG. 3).

After the user has logged in successfully to the device 20 the user is presented with a choice of pre-programmed websites on the display screen 38 and can select a website by using the keypad of the device and by scrolling through a selection menu on the display screen. The manner in which the websites are pre-programmed into the device 20 is described hereinafter.

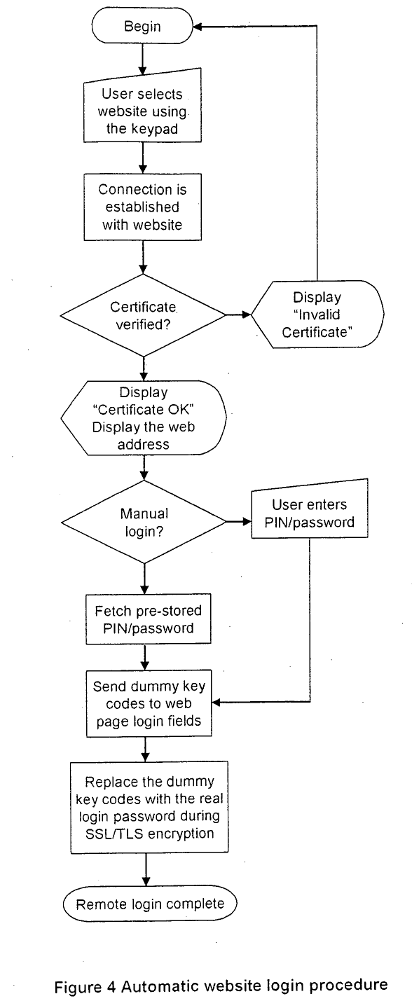

FIG. 4 is a flow chart of steps in an automatic website login procedure. After the website has been selected by the user the device 20 automatically connects to, and logs onto, the selected website, for example an Internet banking website. The user is notified via the display 38 of the authenticity of the website digital certificate and the correctness of the web address. As the device 20 emulates a standard keyboard it can send keystroke codes to the processor 14 and thereby control the operation of the processor. The device can be used to initiate a web session by sending a keystroke code for the “www” button found on a modern multimedia keyboard. This automatically launches the default web browser.

Through the use of normal keystroke codes the device forces the browser to connect to the pre-programmed websites login page and, once this connection is made, the web server initiates an SLL/TLS secure handshake which is performed with the device via the CSP. During this session the device verifies the web server's digital certificate and displays the result to the user. The actual web address may also be displayed. If there is a problem with the web address or certificate the device will terminate the session by using keystroke commands and, optionally, generate a warning e.g. a message on the screen 16. If all is well the web server sends the login page to be displayed on the browser.

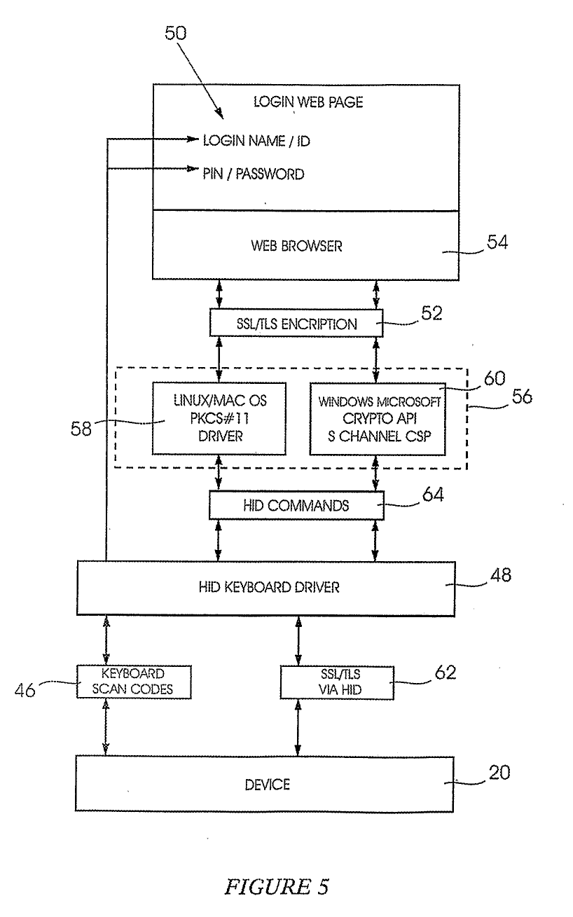

FIG. 5 illustrates in block diagram form a method of automatically logging in to a website. In step 46 the device 20 sends a set of dummy login characters via the processor keyboard driver 48 to the web page login fields 50. In step 52 the web browser 54 sends the completed form to the CSP 56. Allowance is made here for different operating systems e.g. a Linux system 58 and a Windows operating platform 60.

Thereafter the CSP sends (step 62) the SSL/TLS encryption command 64 via the HID keyboard driver 48 to the device 20.

The device 20 then searches for the dummy characters that it inserted into the login form and substitutes these with the user's pre-programmed secret login details. The browser request for SSL/TLS encryption is performed by the device which encapsulates the user's secret login details in an encrypted data packet. The web server receives the SSL/TLS encrypted login data from the browser in a normal manner which is not influenced by the preceding dummy login. Thereafter normal SSL/TLS operations take place between the browser and web server during the remainder of the user session, with the device encrypting and decrypting all SSL/TLS traffic on the browser's side.

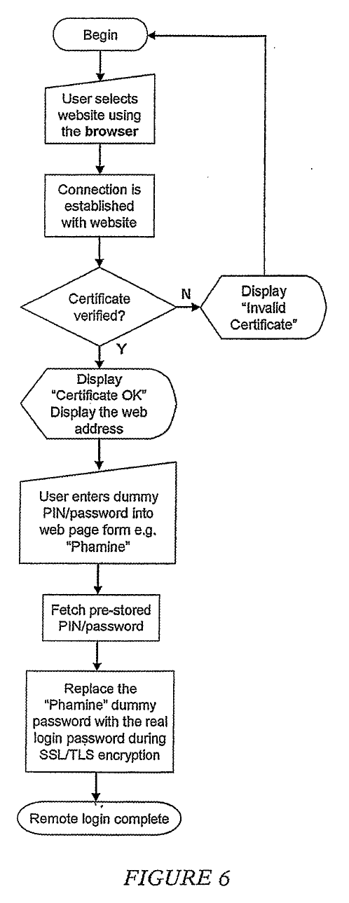

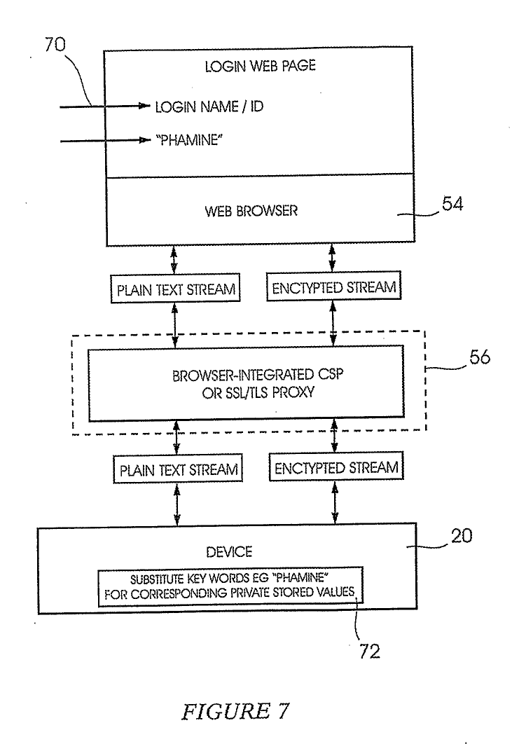

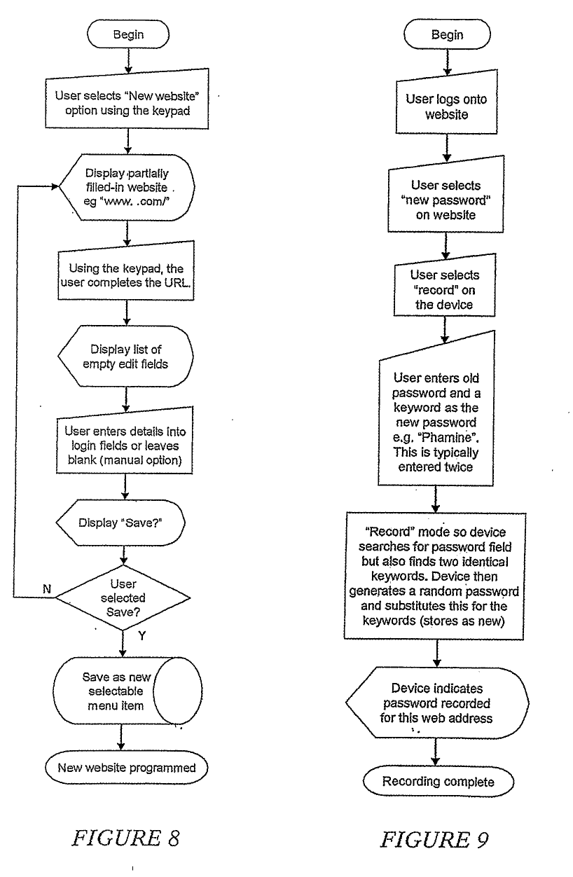

FIG. 6 illustrates steps in a manual website login procedure which can be adopted as an alternative to the automatic login method described in connection with FIGS. 4 and 5. In this instance the user connects to a secure website in a normal manner by using the Internet browser of the processor 14. During the SSL/TLS connection the device recognises the website for which the device has a stored private user password. The user then enters a keyword known to the device, e.g. “Phamine”, instead of a password in the website login page—see FIG. 7, step 70. The device recognises the keyword in the password field to be transmitted to the website and substituted for the user's stored private password—step 72.

A function to program new websites manually into the device 20 can be selected from the menu of the device. The user is then prompted to enter the website details using the keypad 34. Alpha characters are entered using a method similar to that employed on a cellular telephone. To simplify this process though a support website of the device (referred to hereinafter) could maintain a list of common security websites such as major banks, eBay, Amazon, PayPal and so on. The user then selects from this list and the device is automatically updated with the website profiles. PINs and passwords can be entered directly via the device.

As an alternative to programming the website and password manually into the device a record mode can be provided, for example in the form of a button on the device or in the form of a menu option. In this mode the device can store the currently connected web address, certificate and so on and even the user's password. An additionally secure method can be used by combining keyword recognition and by allowing the user to create a random unknown password, as is illustrated in the steps in FIG. 9. In this instance the user types in the same keyword in the new password field as well as in a confirmation field on the web page. The device, upon detecting the keywords, then generates a random password for the user and substitutes this for the keywords. This means that not even the user knows what the password is and therefore cannot divulge the password in a social engineering attack. This method also results in the generation of strong random passwords that cannot easily be guessed or cracked.

A support website can be established for the device which has a hard-coded secure communication relationship with this website so that the device can securely download information such as updates. This website can also be used to authenticate a device by recording and then verifying a unique serial number which is assigned to the device. This serial number may be cryptographically coded into each legitimate device during manufacture. The user could then be forced to register with the support website in order to verify the legitimacy of the device.

The system of the invention offers the following significant benefits:

Unfettered adoption: The device requires no back-end support. This is an important feature of the system of the invention. Most secure login devices require back-end support. This is a serious impediment to wide-scale adoption as the solution has to be sold to each service provider. Since the system of the invention protects the user's private data using the standard SSL/TLS secured link with the server, there is no added requirement for the server other than the SSL/TLS link that it already uses. Unfettered by institutions and management decisions, the system of the invention can be marketed and sold directly to the public.

Web server verification: The device contains the digital certificates⁴ of all the main Certification Authorities (CAs). The device will not allow connections with web servers whose certificate cannot be validated using the associated CA's certificate. A fake website may be able to obtain the original server's public key certificate but it cannot use it as it needs the associated private key to be able to decrypt the user's login details. The feature counteracts one of the threats referred to.

Pre-stored website addresses: The device allows the web addresses of frequently visited secure websites to be pre-stored and to be selected from a menu. During certificate verification, the device compares the web address in the received certificate with the pre-stored web address and only allows connection if they match. This feature counteracts one of the threats referred to. The actual certificates of specific websites could also be stored thus allowing direct comparison and hence bypassing the need for CA verification as described hereinbefore.

Automatic login: Since the device appears to the PC as a standard keyboard it can issue keyboard commands just like a user. It can therefore make use of special function keys like the “www” key found on multimedia keyboards. By using this feature combined with other standard special function key codes the device is able automatically to initiate a web session, secure a connection and login with a web server.

Works even on hacked PCs: User PINs and passwords used by the device for online logins as well as other private codes and numbers that are entered or pre-stored never appear on the PC or Internet in unencrypted form and are therefore always protected between the device and the web server. Thus users can still conduct their secure Internet business even in the face of a seriously hacked PC. The worst that can happen is that the CSP is bypassed or modified, but this only presents a nuisance factor as the user will notice if the processor 14 requires a login but not the device. This feature counteracts one of the threats referred to.

Only one PIN to remember: Many login PINs and passwords can be securely stored by the device and used on the user's behalf. The only PIN that a user need remember is the pin of the device and this is of no use to anyone except the holder of the device. Even indirect attacks such as “phishing”, “pharming”, “spoofing”, “man-in-the-middle”, etc. can be thwarted since the user need not enter a website's PIN or password. The user may eventually forget what password is being used and may therefore not be capable of disclosing the password. This feature defends against two of the threats referred to.

Paranoid feature: A user may choose not to pre-store the private data in the device. In this case the information must be entered on the device each time instead of on the web page. The device then sends dummy keystrokes into the web page field and replaces the dummy code with the private information during the encryption of the web page before it is sent to the server. This manual method might also be a requirement when more than one person needs to use the device. However in this case the user may wish to consider the smart card option and the fingerprint recognition option.

Visual confirmation: By filtering on special keywords or based on a profile, the device can be made to display specific information on its integrated display. This can be used for confirmation of data entry or for delivering initial passwords which can be viewed only on the device. In this case the device substitutes the information with dummy information to be displayed on the PC screen.

Smart card option: The device provides an integrated smart card reader and can use externally inserted smart cards to store personal details, website addresses, login passwords etc. The device PIN then becomes the smart card PIN. The smart card itself will not allow access to the user's secrets without entry of the correct PIN. This option allows the device to be used with multiple users, each with a smart card and unique PIN.

Fingerprint option: The device provides a fingerprint scanner option and built-in fingerprint recognition. This feature can be used on its own to authenticate a user, or together with the device PIN or together with the smart card option. In the last case the user's fingerprint matching template can be stored on the user's smart card. With all three options enabled, the main tenets of access control are satisfied i.e. “What you have” (smart card), “What you know” (PIN) and “What you are” (fingerprint).

Client-side SSL/TLS: The device can be used to enhance the security of client-side SSL/TLS⁵. The user's private key is stored in the device's secure memory and can only be unlocked for use by the user logging in directly to the device. Since the private key is now portable⁶, it can be used on other computers and can be locked away when not needed.

1-11. (canceled)

12. A method of providing cryptographically secure bi-directional communication over a communication network between a user at a client computer and at least one server computer which includes the steps of connecting a secure hardware device to the client computer, implementing a network cryptographic protocol and integrating user interfaces on the secure hardware device so that a secure path is created between the server computer and the user via the integrated user interfaces thereby preventing disclosure on the client computer or on the network of selective user input and output information in unencrypted form, wherein the input information which is input by the user via an integrated user interface consists of server login and other private data, and wherein the output information displayed to the user via an integrated user interface consists of user notifications and warnings originating from the server computer or the secure hardware device.

13. A method according to claim 12 in which the communication network is the Internet and the network cryptographic protocol is an Internet browser security protocol.

14. A method according to claim 12 wherein the identity of the user is verified by the secure hardware device via the integrated user interfaces, by at least one of the following:
by verifying a personal identification number input by the user to the secure hardware device;
by verifying biometric data of the user; and
by verifying a smart card.

15. A method according to claim 14 wherein the secure hardware device includes a secure memory and which includes the step of storing information in the memory which may only be used by the secure hardware device after successful user identity verification, and wherein the information is selected from the network address of the server computer; information which allows the identity of the server computer to be verified by the network cryptographic protocol; the user's server login information; and a digital certificate of the user.

16. A method according to claim 12 which includes the step of displaying the identity of the server computer on an integrated user interface, wherein the identity is selected from the name of an organisation which controls the server computer, the name of the server, and the server computer's network address.

17. A method according to claim 12 wherein the secure hardware device includes a secure memory and which includes the step of storing information in the memory which may only be used by the secure hardware device after successful user identity verification, wherein the information is selected from the network address of the server computer; information which allows the identity of the server computer to be verified by the network cryptographic protocol; the user's server login information;
and a digital certificate of the user, and which includes the further steps of allowing the identity of the server computer to be verified by the network cryptographic security protocol and, if verification is successful, using the secure hardware device to automatically connect the client computer to the server computer and to login to the server computer on behalf of the user and, if verification is unsuccessful, generating a warning to the user via an integrated user interface.

18. A method according to claim 12 wherein the secure hardware device includes a secure memory and which includes the steps of storing a digital certificate of the user in the secure memory which may only be used by the secure hardware device after successful user identity verification, and using the server computer to verify the identity of the user using the network cryptographic protocol.

19. A method according to claim 12 wherein the secure hardware device includes a secure memory and which includes the step of storing information in the memory which may only be used by the secure hardware device after successful user identity verification, wherein the information is selected from the network address of the server computer; information which allows the identity of the server computer to be verified by the network cryptographic protocol; the user's server login information;
and a digital certificate of the user and which includes the further steps of using a keyword in unencrypted data from the server computer or from the client computer as a directive to the secure hardware device to do at least one of the following: to display information on the integrated user interface, insert or substitute information originating from the user via an integrated interface or from the pre-stored information, and performing a digital signature function only after successful user identity verification according to at least one of the following:
by verifying a personal identification number input by the user to the secure hardware device;
by verifying biometric data of the user; and
by verifying a smart card.

20. A method according to claim 12 wherein the secure hardware device includes a secure memory and which includes the step of storing information in the memory which may only be used by the secure hardware device after successful user identity verification, wherein the information is a selected from the network address of the server computer; information which allows the identity of the server computer to be verified by the network cryptographic protocol; the user's server login information;
and a digital certificate of the user and wherein the stored information is transferred to the server computer thereby allowing direct implementation of the method on an existing communication network.
